(19) United States
(12) Patent Application Publication
(10) Pub. No.: US 2013/0014426 A1
(43) Pub. Date: Jan. 17, 2013

(54) APPARATUS FOR SECURING FISHING TACKLE

(71) Applicants: James Mikel Brown, Mesa, AZ (US); John Eldo Brown, Phoenix, AZ (US)

(72) Inventors: James Mikel Brown, Mesa, AZ (US); John Eldo Brown, Phoenix, AZ (US)

(21) Appl. No.: 13/548,051

(22) Filed: Jul. 12, 2012

Related U.S. Application Data
(60) Provisional application No. 61/506,770, filed on Jul. 12, 2011.

(51) Int. Cl. A01K 97/06

(52) U.S. Cl. 43/25.2

(57) ABSTRACT

A retaining apparatus for fishing tackle is provided. The retaining member comprises a main body defining a hollow interior, and coupling means for releasably coupling the retaining member to a fishing rod, wherein the hollow interior houses the fishing tackle. The coupling means may comprise an engagement member that pivots about the main body between an engaged position and an open position, the engagement member being biased toward the engaged position, wherein pivoting the engagement member to the open position allows the retaining member to be placed on or removed from the fishing rod and pivoting the engagement member to the engaged position secures the retaining member to the fishing rod.

### CROSS REFERENCE TO RELATED APPLICATION[S]

This application claims priority to U.S. Provisional Patent Application to Brown entitled “APPARATUS FOR SECURING FISHING TACKLE,” Ser. No. 61/506,770, filed Jul. 12, 2011, the disclosure of which is hereby incorporated entirely herein by reference.

### BACKGROUND

1. Technical Field

This invention relates generally to fishing equipment and in particular to a retaining apparatus for the safe and secure storage of fishing tackle.

2. State of the Art

Fishing is a broad term describing the activity of trying to catch fish. Fishing can be done wherever fish are located, such as in shallow water, i.e., lakes, rivers, and streams, or in deep water, i.e., seas and oceans. Fishing includes various fish catching techniques including, but not limited to, hand gathering, spearing, netting, angling and trapping.

Angling is a method of fishing by means of an “angle,” or in other words a fish hook, the fish hook being intended to hook into the mouth region of the wanted fish. The hook is usually attached to a fishing line and the line is often attached to a fishing rod. The fishing rod is usually fitted with a fishing reel that functions as a mechanism for storing, retrieving and paying out the line. The hook is usually dressed with lures or bait that help disguise the hook and entice the fish into swallowing the hook. Some lures incorporate one or more hooks, such as single-, double-, or treble-hooks.

To catch fish, the fisherman uses the fishing rod to cast the lure out into the water. Thereafter, depending on the type of angling being performed, the fisherman uses various techniques to move the lure to attract and entice a fish to engage the hook. Once the fish is hooked, the fisherman reels in the fishing line to draw the fish toward the fisherman, where the fisherman can grab the fish, remove the hook from the fish, and either keep the fish or release the fish back into the water.

However, the safe and secure storage of fishing hooks and fishing lures while they are not deployed in the water, or otherwise not in use, has long been a problem for fisherman of all ages and experience levels. When a fishing hook or lure is out of the water, the hook of the lure is exposed and has the potential to inadvertently snag or catch on other objects and persons. This presents a danger to those objects and persons in the vicinity of the fishing rod.

Thus, there is a need in the fishing industry for an apparatus and method that addresses the concerns described above and provides for the safe and secure retention and storage of fishing hooks and fishing lures while not in use.

### SUMMARY

The following relates to fishing equipment and in particular to a retaining apparatus capable of attaching to a fishing rod and structured to provide for the safe and secure storage of fishing tackle.

A first general aspect relates to a retaining member for securing fishing tackle, the retaining member comprising a main body defining a hollow interior, and coupling means for releasably coupling the retaining member to a fishing rod, wherein the hollow interior is configured to receive the fishing tackle.

Another general aspect relates to the main body further comprising a first end and a second end, the first end being open and the second end being closed.

Another general aspect relates to the coupling means further comprising a groove, the groove being defined in an exterior surface of the main body and being oriented axially along the main body, the groove being configured to receive the fishing rod therein.

Another general aspect relates to the coupling means further comprising an engagement member that pivots with respect to the main body between first second, and third positions, the engagement member being biased toward the first position, wherein pivoting the engagement member to the third position allows the retaining member to be coupled to or decoupled from the fishing rod and pivoting the engagement member to the second position secures the retaining member to the fishing rod.

Another general aspect relates to the main body further comprising a slot, the slot being oriented axially along the main body, the slot being open at a first end of the main body and running a predetermined distance along the main body, the slot being configured to receive a shaft of a hook of the fishing tackle.

Another general aspect relates to an opening in the main body, the opening being positioned near the second end of the main body.

Another general aspect relates to the coupling means further comprising a groove defined by an exterior surface of the main body, wherein under the condition that the retaining member is secured to the fishing rod, the groove engages the fishing rod and the engagement member secures the fishing rod in the groove in the second position.

Another general aspect relates to the coupling means further comprising a flange and a biasing member, the flange protruding from the main body, and the biasing member being positioned between the flange and the engagement member to bias the engagement member toward the first position.

Another general aspect relates to a retaining member for securing fishing tackle, the retaining member comprising a main body defining a hollow interior, the main body having a first end and a second end, the first end being open and the second end being closed; and an engagement member functionally coupled to the main body that pivots with respect to the main body between a closed position and an open position, the engagement member being configured to engage an exterior surface of the main body in the closed position.

Another general aspect relates to the retaining member further comprising a flange extending from the exterior surface of the main body; and a biasing member, the biasing member being functionally configured between the flange and the engagement member to bias the engagement member toward the closed position.

Another general aspect relates to the retaining member further comprising a slot in the main body, the slot initiating from the first end and being open to the first end, the slot extending a distance down the main body toward the second end.

Another general aspect relates to the retaining member further comprising a groove defined in an exterior surface of the main body, wherein the groove is configured in the main body such that the engagement member covers a portion of the groove in the closed position.

Another general aspect relates to the retaining member further comprising an opening in the main body near the second end.

Another general aspect relates to the main body being cylindrical and the main body further comprising a first portion and a second portion, wherein the first portion is proximate the first end and the second portion is proximate the second end, the first portion having a diameter larger than a diameter of the second portion.

Another general aspect relates to an axial length of the engagement member corresponding to an axial length of the groove.

Another general aspect relates to the slot being configured in the first portion and the groove being configured in the first and second portions.

Another general aspect relates to the engagement member further comprising an engagement portion; and a gripping portion, wherein the engagement portion is configured to functionally engage the exterior surface of the main body and cover a groove in the main body in the closed position, and wherein the gripping portion is configured such that applying force to the gripping portion engages the biasing member to facilitate the transitioning of the engagement portion from the closed position to an open position.

Another general aspect relates to a method of securing fishing tackle to a fishing rod, the method comprising providing a retaining member; securing the retaining member to the fishing rod; and placing the fishing tackle inside the retaining member.

Another general aspect relates to the method of the securing the retaining member to the fishing rod further comprising transitioning an engagement member from a closed position to an open position, wherein in the closed position the engagement member engages an exterior surface of the retaining member and in the open position a groove in the exterior surface is revealed; placing the fishing rod in the groove; and transitioning the engagement member from the open position to an engaged position, wherein in the engaged position the fishing rod is retained in the groove between the groove and the engagement member.

Another general aspect relates to the method of the placing the fishing tackle inside the retaining member further comprising inserting the fishing tackle in a hollow interior of the retaining member defined by a main body of the retaining member; and inserting a shaft of a hook of the fishing tackle in a slot defined in the main body of the retaining member.

The foregoing and other features, advantages, and construction of the present disclosure will be more readily apparent and fully appreciated from the following more detailed description of the particular embodiments, taken in conjunction with the accompanying drawings.

### BRIEF DESCRIPTION OF THE DRAWINGS

Some of the embodiments will be described in detail, with reference to the following figures, wherein like designations denote like members.

FIG. 1a depicts a side perspective view of an embodiment of the retaining apparatus.

FIG. 1b depicts a side perspective, line-drawing view of an embodiment of the retaining apparatus depicted in FIG. 1a.

FIG. 1c depicts a side perspective view of an embodiment of the retaining apparatus depicted in FIG. 1a.

FIG. 2a depicts a top view of an embodiment of the retaining apparatus.

FIG. 2b depicts a side view of an embodiment of the retaining apparatus depicted in FIG. 2a.

FIG. 2c depicts a side view of an embodiment of the retaining apparatus depicted in FIG. 2a.

FIG. 3 depicts a side perspective view of an embodiment of the retaining apparatus.

FIG. 4 depicts a top view of an embodiment of the retaining apparatus engaging a fishing rod.

FIG. 5a depicts a top view of an embodiment of the retaining apparatus.

FIG. 5b depicts a side view of an embodiment of the retaining apparatus depicted in FIG. 5a.

FIG. 5c depicts a side view of an embodiment of the retaining apparatus depicted in FIG. 5a.

FIG. 5d depicts a side view of an embodiment of the retaining apparatus depicted in FIG. 5a.

FIG. 6 depicts a side perspective view of an embodiment of the retaining apparatus coupled to a fishing rod.

### DETAILED DESCRIPTION OF EMBODIMENTS

A detailed description of the hereinafter described embodiments of the disclosed apparatus and method are presented herein by way of exemplification and not limitation with reference to the Figures listed above. Although certain embodiments are shown and described in detail, it should be understood that various changes and modifications may be made without departing from the scope of the appended claims. The scope of the present disclosure will in no way be limited to the number of constituting components, the materials thereof, the shapes thereof, the relative arrangement thereof, etc., and are disclosed simply as an example of embodiments of the present disclosure.

As a preface to the detailed description, it should be noted that, as used in this specification and the appended claims, the singular forms “a”, “an” and “the” include plural referents, unless the context clearly dictates otherwise.

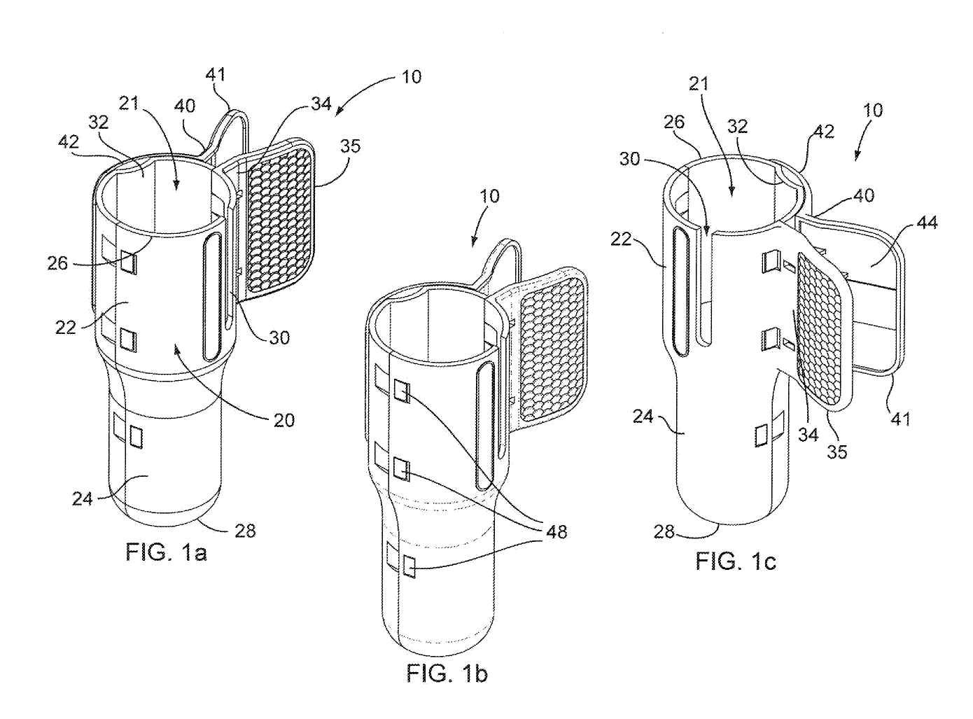

Referring to the drawings, FIGS. 1a-1c depict an embodiment of a retaining member 10. The retaining member 10 may include a main body 20, a slot 30, a groove 32, a flange 34, and an engagement member 40. The main body 20 may be tubular in shape and the side walls of the tubular main body 20 may define a hollow interior space 21 therebetween. The main body 20 may include a top end 26 and a bottom end 28. The top end 26 may be open to permit the insertion and/or removal of fishing tackle, fishing lures, and other fishing equipment attached to the fishing line of a fishing rod 50. The bottom end 28 may be a closed end, such that the bottom end 28 prevents the fishing tackle, fishing lures, and other fishing equipment attached to the fishing line of the fishing rod 50 from passing completely through the hollow interior space 21 of the main body 20 once inserted into the hollow interior space 21.

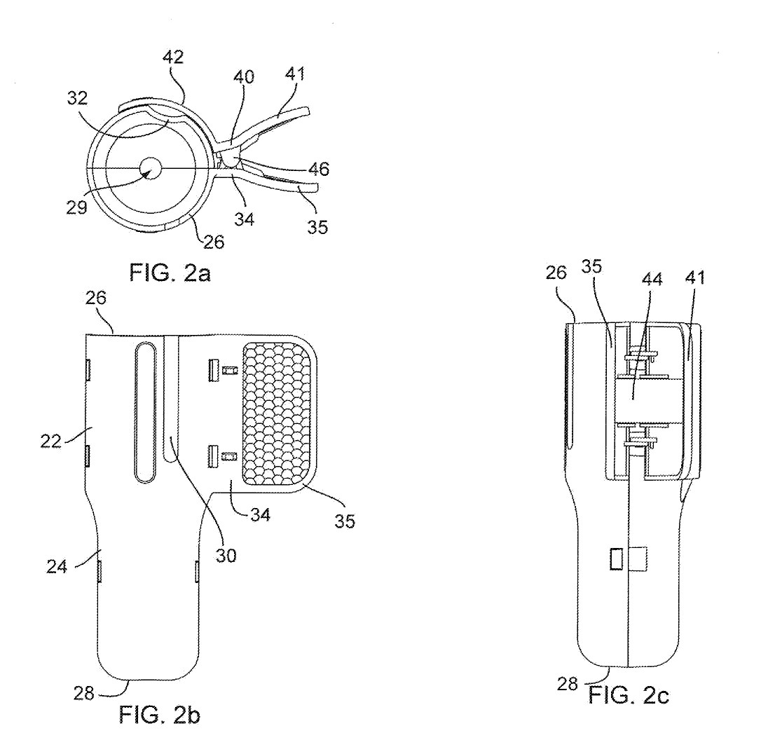

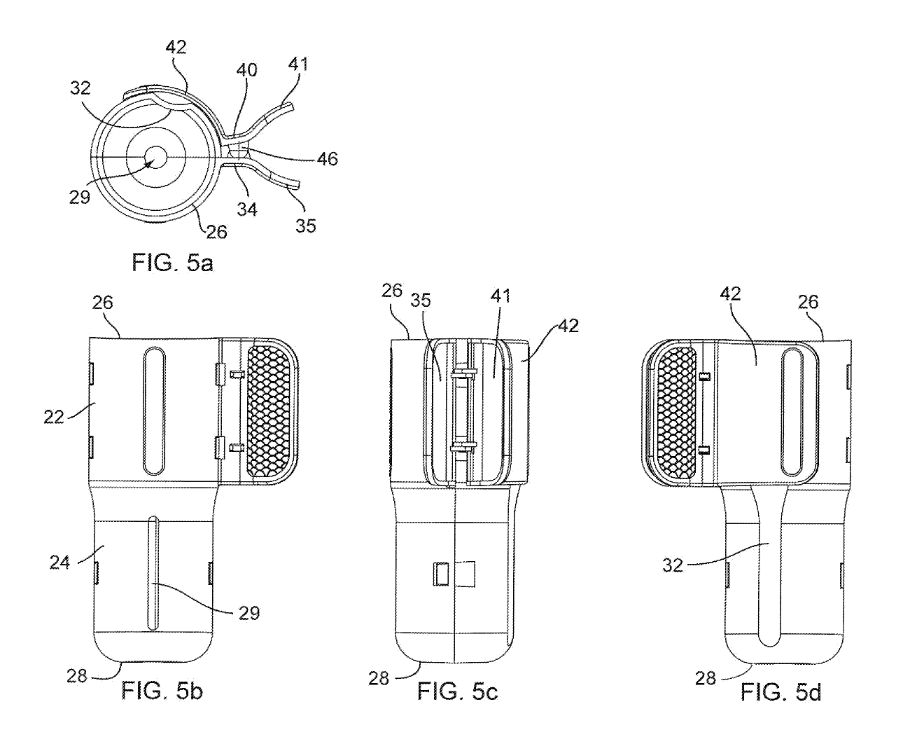

Moreover, embodiments of the retaining member 10 may include the bottom end 28 being tapered, or otherwise narrowing, to allow the retaining member 10 to fit or to be more easily inserted into a holding device that holds the fishing rod 50. In addition, the main body 20 may further include a hole 29, as shown in FIGS. 2a, 4, 5b and 5a, in the main body 20 to allow the interior space 21 to communicate with the space outside the retaining member 10, such that any fluids within the retaining member 10 may drain from the retaining member 10. Embodiments of the retaining member 10 may include the hole 29 being positioned directly in the bottom end 28, as shown for example in FIG. 2a. Embodiments of the retaining member 10 may include the hole 29 being positioned in any of the sidewalls of the main body 20, as shown for example in FIG. 5b. The hole 29 may be positioned proximate the bottom end 28 to allow the majority, or all, of fluid that may be in the main body 20 to drain from the retaining member 10. Embodiments of the retaining member 10 may further comprise a plurality of holes 29 that allow any fluid in the retaining member 10 to quickly and efficiently drain therefrom. The holes 29 may be positioned in the bottom end 28, in the sidewalls of the main body 20, or a combination of both.

The main body 20 may include a first portion 22 and a second portion 24. Each of the first portion 22 and the second portion 24 may be tubular in shape, with the diameter of the first portion 22 being larger than the diameter of the second portion 24. The larger diameter of the first portion 22 may assist in the easy and efficient insertion of the fishing tackle, fishing lures, and other fishing equipment attached to the fishing line of the fishing rod 50 into the interior hollow space 21 of the main body 20. The smaller diameter of the second portion 24 may restrict or otherwise hinder the fishing tackle, fishing lures, and other fishing equipment attached to the fishing line of the fishing rod 50 from excessively shifting, or otherwise moving, within the interior hollow space 21 once inserted into the main body 20.

Embodiments of the retaining member 10 may further include a slot 30. The slot 30 may be positioned in the sidewall of the main body 20 in the first portion 22. The slot 30 may be positioned such that the slot 30 opens up into the top end 26 of the main body 20. The slot 30 may extend a predetermined distance axially along the sidewall of the main body 20. The slot 30 may have a width that is sufficient to have a hook of a fishing lure inserted therein. Specifically, the width of the slot 30 may be large enough to receive a shank of a fish hook, but narrower than the distance between the shank and the point of a hook, commonly referred to as the gap, such that the slot 30 prevents the points of the hook from passing through the slot 30. The width of the slot 30 may also be small enough to prevent treble-hooks from passing through the slot 30. With treble hooks, the width of the slot 30 may be smaller than a standard distance between each of the respective points of the three hooks, such that the hooks of the treble-hook cannot pass through the slot 30 once the shaft of the treble-hook has been inserted into the slot 30. It follows that in embodiments of the retaining member 10, a fishing lure may be inserted into the main body 20 of the retaining member 10, while the shaft of the hook on the lure is slid into the slot 30 such that the hook is retained within the slot 30. Embodiments of the retaining member 10 may further comprise a plurality of slots 30 in the main body 20, such that multiple hooks may be retained by the respective slots 30 once the fishing lure is placed in the main body 20.

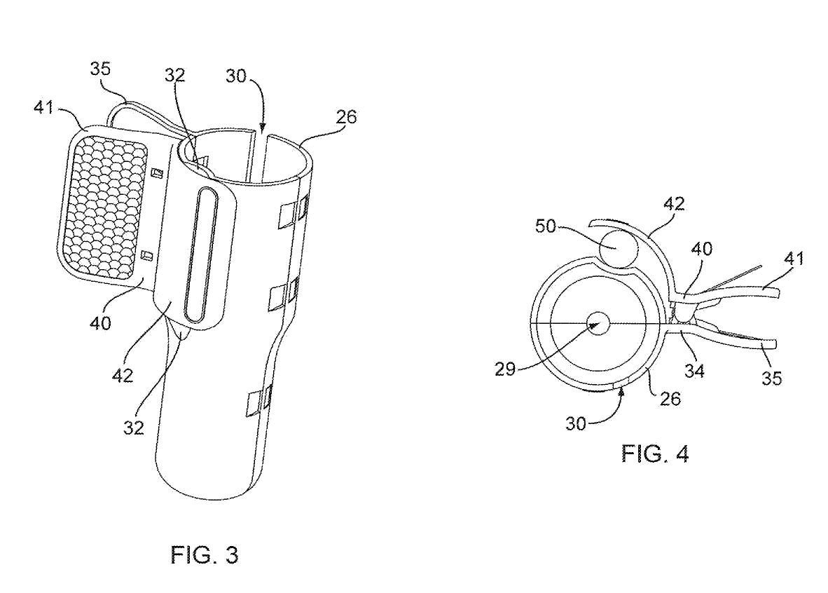

Referring to the drawings, FIGS. 1a-1c, 2a and 2d depict a groove 32 in the main body 20. The groove 32 may be aligned axially with the main body 20 such that the axis of the groove 32 and the axis of the main body 20 may be substantially parallel. The groove 32 may be structured to receive the shaft of the fishing rod 50. As such, the width of the groove 32, the depth of the groove 32, and the shape of the groove 32 may be determined based on the size and shape of the fishing rod 50 to which the retaining member 10 is to be coupled. Embodiments of the retaining member 10 may include the groove 32 being an arc-shaped, concave surface running a distance down the axial length of the main body 20. Embodiments of the retaining member 10 may include the groove 32 being a rectangular-shaped indention running a distance down the axial length of the main body 20. Embodiments of the retaining member 10 may include the groove 32 being a triangular-shaped indention running a distance down the axial length of the main body 20. Other shapes of the groove 32 that serve to functionally engage the fishing rod 50 and secure the shaft of the fishing rod 50 in the groove 32 are contemplated by the disclosure of the groove 32. The groove 32 may run down the exterior of the main body 20 a predetermined distance that is not as long as the complete length of the main body 20, as shown for example in FIG. 3. Alternatively, the groove 32 may run down the entire length of the exterior of the main body 20 to more fully secure the fishing rod 50 therein, as shown for example in FIG. 5d. The groove 32 may be positioned in the first portion 22 of the main body 20, as shown for example in FIG. 3, or may also be positioned in both the first portion 22 and the second portion 24 of the main body 20, as shown for example in FIG. 5d.

Referring to the drawings, FIGS. 1a-1c, 2a and 2c depict a flange 34 protruding from the main body 20, an engagement member 40, and a biasing member 44 positioned therebetween. The flange 34 may extend radially from the main body 20. The flange 34 may include a flared portion 35. The engagement member 40 may comprise a gripping section 42 and a flared portion 41 that cooperates with the flared portion 35 of the flange 34. The engagement member 40 may be coupled to the flange 34 at a pivot point 46 positioned on the flange 34. The engagement member 40 may also couple to the main body 20 at a pivot point 46 positioned on the main body 20. The flange 34 and the engagement member 40 may cooperate to flex the biasing member 44. The engagement member 40 may also pivot about the pivot point 46 positioned between the flange 34 and the engagement member 40. By placing compressive force on the corresponding flared portions 35 and 41, the compressive forces may flex the biasing member 44 positioned between the flared portions 35 and 41 such that the gripping section 42 of the engagement member 40 may be pivoted about the pivot point 46 between a closed position, an open position, and an engaged position. The biasing member 44 may normally be biased to force the gripping section 42 of the engagement member 40 to rest normally in the closed position against the exterior of the main body 20.

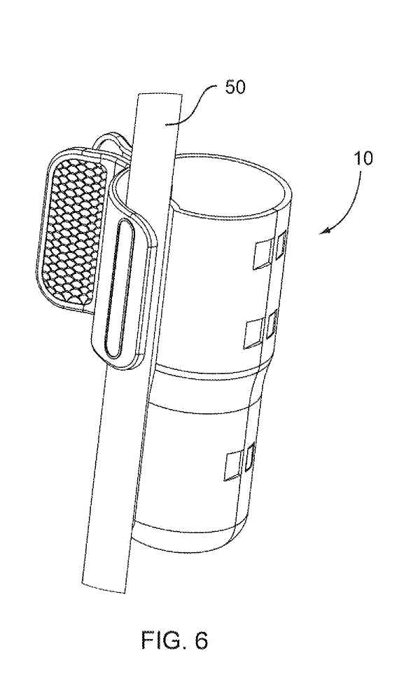

Embodiments of the retaining member 10 may include the gripping section 42 having a size and shape that corresponds to the size and shape of the main body 20. The gripping section 42 may be arc-like in shape and the shape of the arc may correspond to the shape of the outer diameter of the tubular main body 20. The gripping section 42 may also be configured to overlap the groove 32 in the main body 20. Thus, in the closed position, the gripping section 42 may rest over the groove 32, as shown in FIGS. 1a-1c. However, as mentioned above, application of compressive force on the flared portions 35 and 41 to force the flared portions 35 and 41 toward one another to flex the biasing member 44 may allow the engagement member 40 to pivot about the pivot point 46 to permit the gripping section 42 to rise up off the main body 20 to the open position, wherein the groove 32 is exposed. Once the gripping section 42 is in the open position, the retaining member 10 may be placed onto the shaft of the fishing rod 50 such that the shaft of the fishing rod 50 is placed within the groove 32 and between the gripping section 42 and the groove 32. Once the shaft of the fishing rod 50 is in this position, the compressive forces on the flared portions 35 and 41 can be relaxed to permit the biasing member 44 to force the flared portions 35 and 41 away from one another to permit the engagement member 40 to pivot about the pivot point 46 to allow the gripping section 42 to move to the engaged position, as shown for example in FIGS. 4 and 6, wherein the gripping section 42 clamps down on and engages the shaft of the fishing rod 50. Once in the engaged position, the gripping section 42 may functionally couple the retaining member 10 to the fishing rod 50 and may deter the retaining member 10 from disengaging from the fishing rod 50. Moreover, because the gripping section 42 moves about a pivot point 46, the gripping section 42 may open up wide enough to accept variously-sized diameters of shafts of fishing rods 50. The gripping section 42 may also include a soft-touch overmolding layer on the interior surface, such that the gripping section does not damage or scrape the shaft of the fishing rod but nevertheless provides ample gripping capabilities to secure the retaining member 10 to the fishing rod 50. In addition, a soft-touch overmolding layer may be placed within the groove 32 for the same purpose.

Embodiments of the retaining member may further include the gripping section 42 having an axial length that is substantially equivalent to the length of the groove 32, such that the gripping section 42 covers the entire length of the groove 32. In this configuration, the axial length of the gripping section 42 may be longer than the axial length of the engagement member 40, which may correspond more or less to the axial length of the flange 34.

Embodiments of the retaining member 10 may include each of the flared portions 35 and 41 having friction-enhanced exterior surfaces that may assist in the gripping of and application of force to the respective flared portions. The friction-enhanced surfaces may be ribbed, indented, grooved, dimpled, textured, or otherwise altered to provide increased gripping characteristics.

Embodiments of the retaining member 10 may include a cap (not shown) that may cover the open top end 26. The cap may pivot between a closed position that closes the open top end 26 and an open position that exposes the top end 26. In the open position, lures and other fishing equipment may be inserted through the top end 26 into the hollow interior space 21 of the main body 20. Thereafter, the cap may be transitioned to the closed position to retain the fishing lure or other fishing equipment within the main body 20.

Embodiments of the retaining member 10 may include a biasing member 44 that is comprised of a spring or other member exhibiting elastic properties. The biasing member may be a compressive member, such as a compressive spring, that is biased to the open position. The biasing member may also be a torsion member, wherein the torsion member is biased to the open position. Embodiments of the torsion member may include a stainless steel metal torsion member. Having the biasing member 44 biased to the open position forces the flared portions 35 and 41 apart, which forces the gripping section 42 into the closed position. Other biasing members known in the art may be utilized to force the flared portions 35 and 41 apart from one another, and those of ordinary skill in the art will understand that these other biasing members are contemplated by the disclosure of the biasing member 44 herein.

Embodiments of the retaining member 10 may include various means for attaching the main body 20 to the fishing rod 50. For example, in addition to or in place of, the engagement member 40, embodiments of the retaining member 10 may include Velcro® means for attaching the main body 20 to the fishing rod 50, wherein, a Velcro® strap may be attached to the main body 20 and may wrap around the fishing rod 50 to couple the retaining member 10 to the fishing rod 50. In addition, embodiments of the retaining member 10 may further include suction cups (not shown) attached to the main body 20 that help secure the retaining member 10 to the fishing rod 50 or other surfaces by means of suction, specifically flat surfaces. In addition, embodiments of the retaining member 10 may further include clips or molded snaps (not shown) attached to the main body 20 that help secure the retaining member 10 to the fishing rod 50, wherein the clips or molded snaps may be clipped on or snapped onto the shaft of the fishing rod 50 to secure the main body 20 to the fishing rod 50. In addition, embodiments of the retaining member may further include an o-ring or other elastic member (not shown) that may be placed around both the main body 20 and the fishing rod 50 to couple the main body 20 to the fishing rod 50.

Embodiments of the retaining member 10 may include a main body 20 that comprises two parts that may be fixedly fastened together during manufacture or releasably fastened together by a consumer. As shown in FIG. 1b, the main body 20 may comprise fastening means 48 that serve to fasten the two parts of the main body 20 together. The main body 20 may be manufactured as two individual corresponding parts that may be fixedly assembled after manufacture such that the corresponding parts do not thereafter separate. Alternatively, the main body 20 may be manufactured as two individual corresponding parts that may be assembled by the consumer and thereafter disassembled by releasing the fastening means 48. Advantages of having two corresponding parts that form the main body 20 include replacing only one of the corresponding parts should that specific part malfunction or otherwise become damaged or nonoperational. Moreover, each specific corresponding part may be individually sold. One of the corresponding parts may be manufactured to include the flange 34 and the slot 30, whereas the other corresponding part may be manufactured to include the groove 32.

Embodiments of the retaining member 10 may include a bottom end 28 that is open, much like the open top end 26. Nevertheless, a fishing lure or other fishing equipment may be secured within the interior space 21 of the main body 20 despite the open bottom end 28 by securing one of the hooks of the lure into one of the slots 30. The configuration of the slot 30, as described above, can prevent the lure and other fishing equipment secured within the slot 30 from sliding completely through the interior space 21 of the main body 20 because the points of the hook are prohibited from passing through the slot 30, thus retaining the hook within the slot 30 and the lure within the main body 20.

Embodiments of the retaining member 10 may include a gripping surface (not shown) on the exterior of the main body 20. The gripping surface may comprise a rubber-type material that assists in the handling of the retaining member 10 even under wet conditions and prevents the main body 20 from becoming overly slippery due to the wet conditions. Other materials that maintain gripping characteristics under wet conditions may also be employed on the exterior of the main body 20, such as, for example, foam or a layer of surface modifiers that alter the characteristics of the material they are applied to and increase the frictional properties of that material in wet conditions. Also, for example, the exterior of the main body 20 may be altered to include ribs, grooves, dimples, or other textures to assist in the prevention of slippage in wet conditions.

Embodiments of the retaining member 10 may include a buoyant material incorporated into the main body 20, such that the retaining member 10 may float if placed in water. Alternatively, a buoyant device (not shown) may be configured to attach to the main body 20 to prevent the retaining member 10 from sinking in water. Embodiments of the retaining member 10 may include the retaining member 10 being made of transparent materials, such that the fishing lures contained therein can be seen without having to peer into the open top end 26 exclusively.

Embodiments of the retaining member 10 may include an opening (not shown) in the sidewall of the main body 20 that may be used to secure the retaining member 10 to other objects by a rope or other tethering device.

Advantages of the embodiments of the retaining member 10 include efficiently and easily securing fishing lures and hooks to the retaining member 10 and efficiently and easily securing the retaining member 10 to a fishing rod 50. Such a configuration prevents hooks on fishing lures on the ends of a fishing line from inadvertently swinging about during non-use and hooking into objects and persons causing harm and/or damage.

The components defining the above-described retaining member 10 may be formed of any of many different types of materials or combinations thereof that can readily be formed into shaped objects provided that the components selected are consistent with the intended operation of a retaining member for securing fishing tackle. For example, the components may be formed of: rubbers (synthetic and/or natural) and/or other like materials; glasses (such as fiberglass) carbon-fiber, aramid-fiber, any combination thereof, and/or other like materials; polymers such as thermoplastics (such as ABS, Fluoropolymers, Polyacetal, Polyamide; Polycarbonate, Polyethylene, Polysulfone, and/or the like), thermosets (such as Epoxy, Phenolic Resin, Polyimide, Polyurethane, Silicone, and/or the like), any combination thereof, and/or other like materials; composites and/or other like materials; metals, such as zinc, magnesium, titanium, copper, iron, steel, carbon steel, alloy steel, tool steel, stainless steel, aluminum, any combination thereof, and/or other like materials; alloys, such as aluminum alloy, titanium alloy, magnesium alloy, copper alloy, any combination thereof, and/or other like materials; any other suitable material; and/or any combination thereof.

Furthermore, the components defining the above-described retaining member 10 may be purchased pre-manufactured or manufactured separately and then assembled together, as previously described. However, any or all of the components may be manufactured simultaneously and integrally joined with one another. Manufacture of these components separately or simultaneously may involve extrusion, pultrusion, vacuum forming, injection molding, blow molding, resin transfer molding, casting, forging, cold rolling, milling, drilling, reaming, turning, grinding, stamping, cutting, bending, welding, soldering, hardening, riveting, punching, plating, and/or the like. If any of the components are manufactured separately, they may then be coupled with one another in any manner, such as with adhesive, a weld, a fastener (e.g. a bolt, a nut, a screw, a nail, a rivet, a pin, and/or the like), wiring, any combination thereof, and/or the like for example, depending on, among other considerations, the particular material forming the components. Other possible steps might include sand blasting, polishing, powder coating, zinc plating, anodizing, hard anodizing, and/or painting the components for example.

A method of securing fishing tackle will hereinafter be described. The method includes providing a retaining member, placing the fishing tackle within the retaining member, securing the fishing tackle to the retaining member, and coupling the retaining member to a fishing pole.

The method of coupling the retaining member to a fishing pole further comprises transitioning an engagement member from a closed position to an open position, wherein in the closed position the engagement member engages an exterior surface of the retaining member and in the open position a groove in the exterior surface is revealed; placing the fishing rod in the groove; transitioning the engagement member from the open position to an engaged position, wherein in the engaged position the fishing rod is retained in the groove between the groove and the engagement member.

The method of securing the fishing tackle to the retaining member further comprises inserting the fishing tackle in a hollow interior of the retaining member defined by a main body of the retaining member; and inserting a shaft of a hook of the fishing tackle in a slot defined in the main body of the retaining member. Moreover, specific structural and functional details regarding the operation of the component parts of the retaining member are described in detail above and are hereby incorporated in their entirety into the method set forth herein.

While this disclosure has been described in conjunction with the specific embodiments outlined above, it is evident that many alternatives, modifications and variations will be apparent to those skilled in the art. Accordingly, the preferred embodiments of the present disclosure as set forth above are intended to be illustrative, not limiting. Various changes may be made without departing from the spirit and scope of the present disclosure, as required by the following claims. The claims provide the scope of the coverage of the present disclosure and should not be limited to the specific examples provided herein.

What is claimed is:

1. A retaining member for securing fishing tackle, the retaining member comprising:
a main body defining a hollow interior; and
coupling means for releasably coupling the retaining member to a fishing rod,
wherein the hollow interior is configured to receive the fishing tackle.

2. The retaining member of claim 1, wherein the main body further comprises a first end and a second end, the first end being open and the second end being closed.

3. The retaining member of claim 1, wherein the coupling means further comprises a groove, the groove being defined in an exterior surface of the main body and being oriented axially along the main body, the groove being configured to receive the fishing rod therein.

4. The retaining member of claim 1, wherein the coupling means further comprises an engagement member that pivots with respect to the main body between first second, and third positions, the engagement member being biased toward the first position, wherein pivoting the engagement member to the third position allows the retaining member to be coupled to or decoupled from the fishing rod and pivoting the engagement member to the second position secures the retaining member to the fishing rod.

5. The retaining member of claim 1, wherein the main body further comprises a slot, the slot being oriented axially along the main body, the slot being open at a first end of the main body and running a predetermined distance along the main body, the slot being configured to receive a shaft of a hook of the fishing tackle.

6. The retaining member of claim 2, further comprising an opening in the main body, the opening being positioned near the second end of the main body.

7. The retaining member of claim 4, the coupling means further comprising a groove defined by an exterior surface of the main body, wherein under the condition that the retaining member is secured to the fishing rod, the groove engages the fishing rod and the engagement member secures the fishing rod in the groove in the second position.

8. The retaining member of claim 4, the coupling means further comprising a flange and a biasing member, the flange protruding from the main body, and the biasing member being positioned between the flange and the engagement member to bias the engagement member toward the first position.

9. A retaining member for securing fishing tackle, the retaining member comprising:
a main body defining a hollow interior, the main body having a first end and a second end, the first end being open and the second end being closed; and
an engagement member functionally coupled to the main body that pivots with respect to the main body between a closed position and an open position, the engagement member being configured to engage an exterior surface of the main body in the closed position.

10. The retaining member of claim 9, the retaining member further comprising:
a flange extending from the exterior surface of the main body; and
a biasing member, the biasing member being functionally configured between the flange and the engagement member to bias the engagement member toward the closed position.

11. The retaining member of claim 9, the retaining member further comprising:
a slot in the main body, the slot initiating from the first end and being open to the first end, the slot extending a distance down the main body toward the second end.

12. The retaining member of claim 9, the retaining member further comprising:
a groove defined in an exterior surface of the main body, wherein the groove is configured in the main body such that the engagement member covers a portion of the groove in the closed position.

13. The retaining member of claim 9, the retaining member further comprising:
an opening in the main body near the second end.

14. The retaining member of claim 9, wherein the main body is cylindrical and the main body further comprises a first portion and a second portion, wherein the first portion is proximate the first end and the second portion is proximate the second end, the first portion having a diameter larger than a diameter of the second portion.

15. The retaining member of claim 14, wherein an axial length of the engagement member corresponds to an axial length of the groove.

16. The retaining member of claim 14, wherein the slot is configured in the first portion and the groove is configured in the first and second portions.

17. The retaining member of claim 10, the engagement member further comprising:
an engagement portion; and
a gripping portion,
wherein the engagement portion is configured to functionally engage the exterior surface of the main body and cover a groove in the main body in the closed position, and
wherein the gripping portion is configured such that applying force to the gripping portion engages the biasing member to facilitate the transitioning of the engagement portion from the closed position to an open position.

18. A method of securing fishing tackle to a fishing rod, the method comprising:
providing a retaining member;
securing the retaining member to the fishing rod; and
placing the fishing tackle inside the retaining member.

19. The method of claim 18, the securing the retaining member to the fishing rod further comprising:
transitioning an engagement member from a closed position to an open position, wherein in the closed position the engagement member engages an exterior surface of the retaining member and in the open position a groove in the exterior surface is revealed;
placing the fishing rod in the groove;
transitioning the engagement member from the open position to an engaged position, wherein in the engaged position the fishing rod is retained in the groove between the groove and the engagement member.

20. A method of claim 18, the placing the fishing tackle inside the retaining member further comprising:
inserting the fishing tackle in a hollow interior of the retaining member defined by a main body of the retaining member; and
inserting a shaft of a hook of the fishing tackle in a slot defined in the main body of the retaining member.
